(19) United States
(12) Patent Application Publication
(10) Pub. No.: US 2008/0147811 A1
(43) Pub. Date: Jun. 19, 2008

(54) Organization of Identities on a Mobile Communications Device Using Metadata

(76) Inventors: B. Steven Schroeder, San Francisco, CA (US); Elmar Weber, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/940,725

(22) Filed: Nov. 15, 2007

Related U.S. Application Data
(60) Provisional application No. 60/866,089, filed on Nov. 16, 2006.

(51) Int. Cl. G06F 15/16; G06F 3/048

(52) U.S. Cl. 709/206; 715/750; 709/227

(57) ABSTRACT

Methods and apparatus consistent with the invention provide the ability to organize a plurality of user identities on a mobile communication device and to process messages for a plurality of user identities on a mobile communication device. A first-level user interface allows a mobile communication device user to access multiple user identities. Responsive to a selection of a user identity, a second-level user interface including a main data screen associated with the selected user identity is displayed. Responsive to a user selecting data from the main data screen, a third-level user interface is displayed to allow user examination of the selected data. Received messages are categorized and associated with a user identity based on the classification result.

### CROSS-REFERENCE TO RELATED APPLICATION

This application claims priority under 35 U.S.C. § 119(e) to U.S. Provisional Patent Application Ser. No. 60/866,089, “Organization of Identities on a Mobile Communications Device Using Metadata,” filed Nov. 16, 2006. The subject matter of all of the foregoing is incorporated by reference herein in its entirety.

### BACKGROUND OF THE INVENTION

1. Field of the Invention

This invention relates generally to the organization and user interface design for implementing multiple identities (e.g., by a multi-identity client) on a mobile or other communications device. Aspects of the invention include user interfaces and organization of identity related communications information. Examples of applicable types of communication include but are not limited to voice communications, peer to peer messaging, group messaging and message distribution and other forms of digital collaboration.

2. Description of the Related Art

People use identities when interacting with others in their daily lives. They use multiple emails, phone numbers and internet handles depending on the form of communication and privacy required. People generally would like to continue using these identities on a mobile communications device, and generally would prefer to be known by the same identity as used on the Internet.

On a personal computer (PC), users can use multiple identities by maintaining multiple chat or community applications. Alternatively, they may use web browsers and different windows to monitor different community interactions.

On mobile devices or other interface constrained devices, however, the limited screen area available to the user requires a different approach. Existing solutions to this problem are limited to applications that interact with several services through a single, converged user interface, for example, a unified instant messaging interface. This is not suitable for users, who generally want to maintain different identities associated with different services or communities. Additionally, it is difficult to track and organize messages in a single messaging interface that does not consider multiple identities and organizes messages both from other users and from the community using a single identity.

Also, communities prefer to maintain their own branding, so a unified client is not suitable for the service provider that is providing the community or instant messaging service.

### SUMMARY

Methods and apparatus consistent with the invention provide the ability to organize a plurality of user identities on a mobile communication device and to process messages for a plurality of user identities on a mobile communication device. A first-level user interface allows a mobile communication device user to access multiple user identities. Responsive to a selection of a user identity, a second-level user interface including a main data screen associated with the selected user identity is displayed. Responsive to a user selecting data from the main data screen, a third-level user interface is displayed to allow user examination of the selected data.

In one aspect of the invention, received messages are classified and associated with a user identity based on the classification. In one configuration, a classification metric is applied to the received message to classify the message. For example, the received message is categorized based on message type, message action, message purpose, message recipient or message sender. Responsive to the classification, the message is associated with a destination user identity and stored to an inbox associated with the destination user identity. Additionally, a second message rule can be applied to the received message, allowing the message to be stored in a type-specific inbox associated with the user identity. Hence, different user identities are able to include multiple inboxes, with different inboxes corresponding to different types of messages, such as instant messages, short message service messages, multimedia message service messages, e-mail or other data transport protocols.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram of a user interface structure according to one embodiment of the invention.

### DETAILED DESCRIPTION OF THE PREFERRED EMBODIMENTS

Although the embodiment described below relates to a mobile device, the principles described can also be applied to other devices that are communications-enabled, including for example Voice over Internet Protocol (VOIP) and fixed line phones, personal computers (PCs), and other devices.

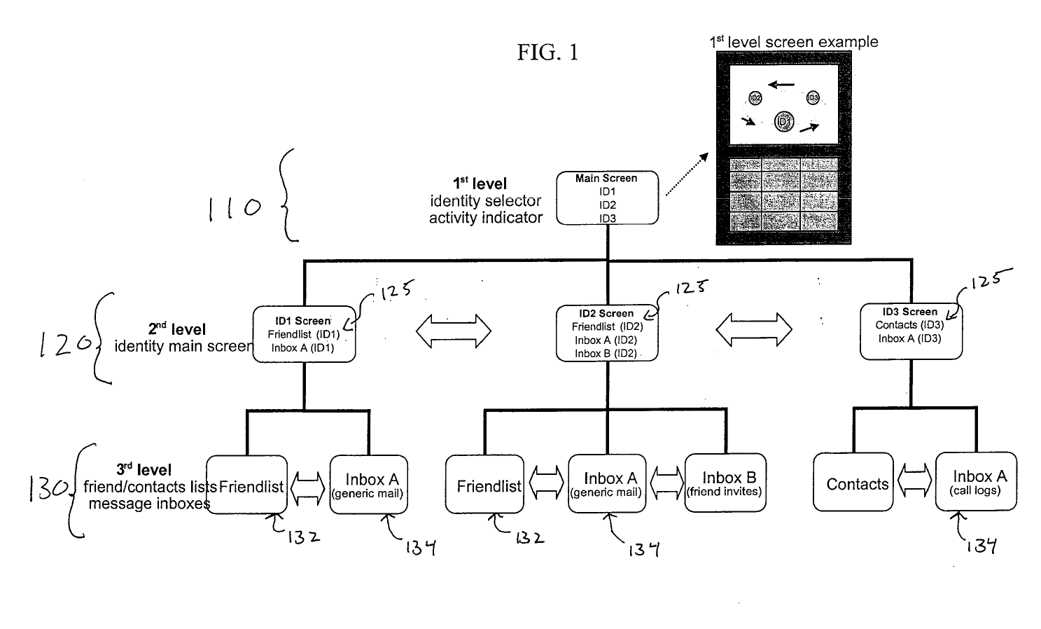

FIG. 1 is a block diagram showing an example user interface (UI) according to the invention. It contains different levels of UI. In this example, the 1^{st} level UI 110 includes a plurality of identities available to the user (ID1, ID2 and ID3) and allows the user to select the identity with which the user would like to communicate.

These identities are typically a representation of an individual for the purpose of communicating with other individuals or interacting with on-line services or communities. Example identities include screen names, nicknames, logins, phone numbers, e-mail addresses, Session Initiation Protocol Uniform Resource Identifiers (SIP URIs) or other forms of community, network, internet or online identification.

In one embodiment, identities are specific to a community or service provider. A community or service provider typically is an organization offering a communication service or website or other network-based facility that facilitates the interaction between individuals or entities. Examples include mobile operators, internet portals, instant messaging service providers, blogging websites, dating websites, commerce websites or similar organization allowing interaction between a plurality of people or entities.

Returning to FIG. 1, by selecting one of the identities in the 1^{st} level user interface 110, the user enters the 2^{nd} level user interface 120, which includes a main screen associated with the selected identity. As an example, the 2^{nd} level user interface 120 and/or the 3^{rd} level user interface 130 include an introduction page 125, a friend list 132, one or more message inboxes 134 and pages shown during screen transitions (e.g., when navigating from one page to another).

One aspect of the invention is a mechanism and user interface for managing and organizing communications that relate to a specific identity. This includes voice, video and messaging communication, but is not limited to these specific forms. Certain embodiments include a user interface for switching back and forth between different identities, allowing the user to easily initiate identity-based communication and to manage identity-based information, messages, history and friends/contacts.

The UI allows a user to monitor communications activity (for example, incoming messages or voice calls) and other state information relating to each identity. For example, the user can monitor communications activity for a non-selected identity while communicating using a selected identity. Event or state change notifications can be delivered to the user by several methods, examples of which include an activity indicator for each identity on the 1^{st} level UI 110, a status bar (statically visible or dynamic), or a pop up screen. In either case, the user receives an indication of communication events or state changes of specific identities.

The 2^{nd} level UI 120 and 3^{rd} level UI 130, which are identity-specific in one embodiment, display notifications of communication events or other state changes relating to the selected identity. Alternatively, the 2^{nd} level UI 120 or 3^{rd} level UI is not identity specific, but display notifications of communication events and other state changes relating to an identity.

The 1^{st} level UI 110 allows a user to scroll through and select different identities. This menu can be a scrollable menu list, one or more tabs, a 3-dimensional carousel or another UI structure allowing identity selection. In an implementation, the 1^{st} level UI 110 provides a view which visually distinguishes the selected identity from non-selected identities, for example by bringing the selected identity into the foreground or some form of highlighting. Many other user interfaces are possible according to the invention. Notifications relating to communication events (e.g., number of total/unread messages, pending friend invite requests, incoming chat requests) can also be displayed on the 1^{st} level UI 110 together with an identity selector.

Upon selection of an identity on the 1^{st} level UI 110, the user is taken to the 2^{nd} level UI 120 where the user is shown different friends and/or messages associated with the selected identity. Each friend can show the number of messages from a user or if a new message has arrived. Based on user, community or operator preferences, friends or messages are shown. After selecting a friend, different default actions are possible (view messages for buddy, call contact, message contact).

The user interface can handle different kinds of messages in an extensible way. Messages can be categorized by message type, action or purpose, and grouped into different inboxes, folders or other organization. Each message type can also have a custom UI template used to display the message. Messages can be mapped to several inboxes based on a set of rules which, in an embodiment, assign the inbox based on the message type. Examples of messages are messages from individual friends, group messages, messages from the service/community site provider, Really Simple Syndication (RSS) feed updates, blog updates, friend invites, voice call events, missed call notifications or other custom message types used by a particular service/community provider. The UI allows for the delivery of messages in a variety of forms, including Short Messaging Service (SMS), Multimedia Messaging Service (MMS), Instant Messaging (IM), Really Simple Syndication (RSS), web services, e-mail and other custom data transport mechanisms.

Each identity supports several inboxes corresponding to specific types of messages (for example, connect request, add friend request, instant messenger (IM), short message service (SMS), multimedia messaging service (MMS), Really Simple Syndication (RSS) feeds, blog updates and custom message types). An inboxes can also have an associated UI template defining the way in which the inbox is displayed. Examples are traditional inbox, ticker, blog reader style, chat client like UI, etc. Icons and other visual elements of each inbox are also customizable.

During UI transitions, such as when navigating from the 1^{st} level UI 110 to the 2^{nd} level UI 120 or when opening a message, custom screens may be displayed which include, for example, branding of the specific identity or advertising.

The identity-specific 2^{nd} level UI 120 and 3^{rd} level UI 130 can contain audiovisual elements (e.g. icons, wallpaper, sounds/music) that are specific to the identity and/or the brand of the community/service provider.

The 2^{nd} level UT 120 and/or 3^{rd} level UI 130 may display a friend list for a specific identity. From this friend list, the user can initiate communication with a specific friend or groups of friends and also see a history of past communication. The UI supports communication via multiple channels as outlined previously. The specific channel used will depend on the choice of the user, communication capabilities of both endpoints (e.g. voice calling capability) and any presence, availability or other applicable communication rule settings.

Hotkeys or buttons specifically for scrolling through IDs can be used. Hotkeys or buttons can also be used for specific actions such as responding or deleting a message.

The UI concept and the underlying data model allow identities to be dynamically added to or removed from the UI.

In one implementation, the UI and specific data for each user including all of his identities is represented as structured data. This structured data can be tied to customizable UI templates, widgets and color schemes and sounds in order to allow each community/service provider to create a unique look & feel for the identity. This may be further customized by the end user. The metadata approach enables flexible rendering of the UI on the target devices using a variety of methods, for example but not limited to:
Mobile browser using traditional Wireless Markup Language (WML), Extensible Hypertext Markup Language (XHTML), Hypertext Markup Language (HTML) with server side rendering.
Mobile browser with additional support for local scripting engine/framework (e.g., AJAX, Flash, Scalable Vector Graphics and scripting (SVG+scripting)). This approach can support local interactivity with widgets and will offer a more responsive UI than the traditional browser approach.
Thick client model, where the UI is constructed on the client using either existing or custom UI widgets. The client is responsible for displaying raw data from the server. In the case of Java/J2ME (MIDP1.0/2.0), a possible implementation is on top of Canvas, GameCanvas or by implementing CustomItems.
Thin client model, where the handset client application is essentially a local display/rendering engine. The visual elements are pre-rendered on the server and synchronized with the client for display. Integration with APIs on the handset supports extended functionality (e.g., access to the phone's camera). This concept can be implemented on top of Java (J2ME), Binary Runtime Environment for Wireless (BREW), Flash, an open operating system (Nokia Series60, Linux, UIQ, Windows Mobile) or other embedded operating system or open software platform.

In one alternative, a less flexible implementation can use fixed number of identities where only pre-defined properties are customized.

What is claimed is:

1. A computer-implemented method for organizing a plurality of user identities on a mobile communication device, comprising:
receiving the plurality of user identities;
generating a first-level user interface including the plurality of user identities;
displaying the first-level user interface; and
responsive to receiving a selection of a first user identity from the plurality of user identities, displaying a main data screen associated with the first user identity.

2. The method of claim 1, further comprising
responsive to receiving a selection of data from the main data screen associated with the first user identity, displaying a third-level user interface including the selected data.

3. The method of claim 2, wherein the third-level user interface comprises a message inbox, a contact listing or a friend list.

4. The method of claim 2, further comprising:
responsive to receiving a communication request while the third-level user interface is displayed, establishing a communication channel with an identified friend.

5. The method of claim 1 wherein the first-level user interface comprises a list of the plurality of user identities.

6. The method of claim 1 wherein the second-level user interface comprises an introduction message and one or more message inboxes.

7. The method of claim 1, wherein the plurality of user identities is less than or equal to a defined number of user identities.

8. A computer-implemented method for processing messages for a plurality of user identities on a mobile communication device, comprising:
receiving a message;
applying a classification metric to the message to generate a message classification;
responsive to the message classification, associating the message with a destination user-identity; and
storing the message to an inbox associated with the destination user identity.

9. The method of claim 8, wherein the classification metric comprises one from the group of a message type, a message action, a message purpose and a message sender.

10. The method of claim 8, wherein associating the message with a destination user identity comprises:
comparing a message rule to the message; and
responsive to the comparison of the message rule to the message, storing the message in a type-specific inbox.

11. The method of claim 8, further comprising:
displaying the message using a user-interface template associated with the destination user identity.

12. The method of claim 8, wherein the message is comprises one from the group of: an instant message (IM), a short messaging service (SMS) message (SMS), a really simple syndication (RSS) feed, electronic mail and a multimedia messaging service (MMS) message.

13. A computer readable medium storing instructions for causing a computer system to execute a method for organizing a plurality of user identities on a mobile communication device, the method comprising:
receiving the plurality of user identities;
generating a first-level user interface including the plurality of user identities;
displaying the first-level user interface; and

14. The computer readable medium of claim 13, wherein the method further comprises:
responsive to receiving a selection of data from the main data screen associated with the first user identity, displaying a third-level user interface including the selected data.

15. The computer readable medium of claim 14, wherein the third-level user interface comprises a message inbox, a contact listing or a friendlist.

16. The computer readable medium of claim 13, wherein the method further comprises:
responsive to receiving a communication request while the third-level user interface is displayed, establishing a communication channel with an identified friend.

17. The computer readable medium of claim 13 wherein the first-level user interface comprises a list of the plurality of user identities.

18. The computer readable medium of claim 13 wherein the second-level user interface comprises an introduction message and one or more message inboxes.

19. The computer readable medium of claim 13, wherein the plurality of user identities is less than or equal to a defined number of user identities.
